(19) United States
(12) Patent Application Publication
(10) Pub. No.: US 2012/0173519 A1
(43) Pub. Date: Jul. 5, 2012

(54) PERFORMING PRE-AGGREGATION AND RE-AGGREGATION USING THE SAME QUERY LANGUAGE

(75) Inventors: Robert Buessow, Zurich (CH); Martin Stolle, Zurich (CH); Bohdan Vlasyuk, Zurich (CH); Olaf Bachmann, Zurich (CH)

(73) Assignee: Google Inc., Mountain View, CA (US)

(21) Appl. No.: 13/388,487

(22) PCT Filed: Jan. 13, 2011
(86) PCT No.: PCT/US11/00057

§ 371 Date: Feb. 2, 2012

(30) Foreign Application Priority Data
Apr. 7, 2010 (US) 12798559

(51) Int. Cl. G06F 17/30

(52) U.S. Cl. 707/722; 707/E17.009; 707/E17.014

(57) ABSTRACT

A method includes: obtaining, at time intervals, subsets of data from a database using code of a query language; performing a pre-aggregation on the subsets of data to produce pre-aggregated data; storing the pre-aggregated data in the database; obtaining, in response to a query, at least some of the pre-aggregated data from the database, where the at least some of the pre-aggregated data is obtained using code from the query language used to obtain the subsets of data; and performing a re-aggregation on the pre-aggregated data to produce re-aggregated data

### TECHNICAL FIELD

This patent application relates generally to performing pre-aggregation and re-aggregation using the same query language.

### BACKGROUND

A standard data analysis approach used when working with data sets is to define, and periodically determine, some pre-aggregation of the data offline, and to subsequently re-aggregate and display the data dynamically using real-ti queries. For example, in a pre-aggregation, the daily revenue for a publisher may be computed with a program that runs daily, and the output of that computation may be stored in a database table. In a re-aggregation, the yearly revenue history for a specific publisher can be computed by running a query on this table. In this example, it would be resource-intensive and slow to examine all of the publisher data every time a query is executed that only concerns a specific publisher. The pre-aggregation organizes the data in this example by publisher, thereby reducing the amount of time it takes to perform the re-aggregation.

Existing systems have a disconnect between the pre-aggregation and the re-aggregation in that the pre-aggregation and re-aggregation are typically written in different query and programming languages, which are stored in different files and maintained by different people.

### SUMMARY

Among other things, this patent application describes a method performed by one or more processing devices, in which the following operations may be performed: obtaining, at time intervals, subsets of data from a database using code of a query language; performing a pre-aggregation on the subsets of data to produce pre-aggregated data; storing the pre-aggregated data in the database; obtaining, in response to a query, at least some of the pre-aggregated data from the database, where the at least some of the pre-aggregated data is obtained using code from the query language used to obtain the subsets of data; and performing a re-aggregation on the pre-aggregated data to produce re-aggregated data.

The method may include any appropriate features described herein, examples of which are the following. The method may include generating a report using the re-aggregated data. The query may request generation of the report. The pre-aggregation may include aggregating values associated with the subsets of data to produce pre-aggregated values. The pre-aggregated values may include sums generated via the pre-aggregation. The re-aggregation may include retrieving one or more pre-aggregated values. The query language may include one or more commands enabling multiple queries to the database. The multiple queries may be substantially concurrent. The pre-aggregated data may include valid clicks of an advertisement from a publisher of the advertisement over a period of time and the re-aggregated data may include valid clicks from multiple publishers of the advertisement over a period of time.

Pre-aggregation may be performed once, and the pre-aggregated data may be used for multiple re-aggregations. Pre-aggregation may be performed automatically, and the time intervals may be periodic. The pre-aggregated data may be stored as one or more tables in the database, and the at least some of the pre-aggregated data may be obtained from the one or more tables.

All or part of the systems and processes described herein may be implemented as a computer program product that includes instructions that are stored on one or more non-transitory machine-readable storage media and that are executable on one or more processing devices. Examples of non-transitory machine-readable storage media include e.g., read-only memory, an optical disk drive, memory disk drive, random access memory, and the like. A or part of the systems and processes described herein may be implemented as an apparatus, method, or electronic system that may include one or more processing devices and memory to store executable instructions to implement the stated functions.

The details of one or more implementations are set forth in the accompanying drawings and the description below. Other features, objects, and advantages will be apparent from the description and drawings, and from the claims.

### DESCRIPTION OF DRAWINGS

FIG. 1 is a block diagram showing pre-aggregation.

FIG. 2 is a block diagram showing re-aggregation.

FIG. 3 is a block diagram of a system on which the processes depicted conceptually in FIGS. 1 and 2 may be implemented.

FIG. 4 is a flowchart showing a process for performing pre-aggregation and re-aggregation using the same query language.

FIG. 5 is a diagram showing a table of pre-aggregated data.

FIG. 6 is a diagram showing a table of re-aggregated data.

FIG. 7 is a block diagram of computing devices on which the processes described herein may be implemented.

Like reference numerals indicate like elements.

### DETAILED DESCRIPTION

Described herein is a process for performing pre-aggregation and re-aggregation using code written in the same query language. Using code of a query language, subsets of data can be obtained, e.g., periodically, from a database. The subsets of data can be, for example, raw data, such as log data. A pre-aggregation can be performed on the subsets of data to produce pre-aggregated data and the pre-aggregated data can be stored in the database. The pre-aggregated data can include, for example, generated sums or other derived data. In response to a query, at least some of the pre-aggregated data can be obtained from the database using code from the same query language used to obtain the subsets of data. A re-aggregation, such as one or more sums or other derivations, can be performed on the pre-aggregated data to produce re-aggregated data. The re-aggregated data can, for example, be included on a report generated in response to the query.

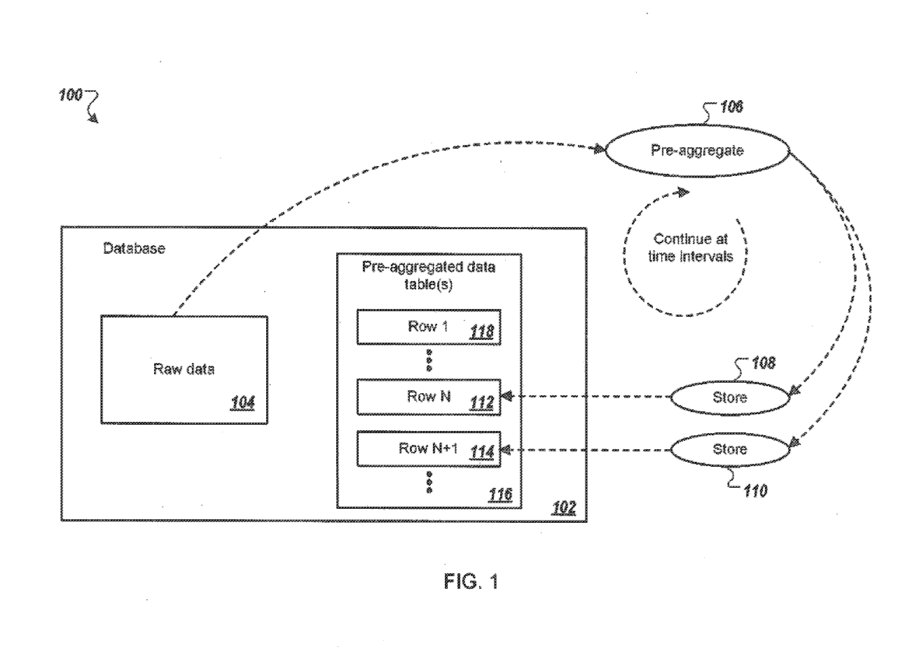

FIG. 1 is a block diagram 100 showing how pre-aggregation is performed. In FIG. 1, a database 102 includes raw data 104. The raw data 104 can be, for example, log data. The raw data 104 can include one or more logs that include information about advertisements displayed on publisher web pages. For example, the raw data 104 can include information about clicks and other interactions performed by users on advertisements or other content, which may occur on one or more days. Although the raw data 104 is shown as included in the database 102, the raw data 104 can be included in one or more databases. As another example, the raw data 104 can be included in one or more files.

The raw data 104 can be of a size (e.g., thirty billion entries) such that processing the raw data 104, such as to query the raw data 104 for information about a particular advertises gent, advertiser, or publisher, can take a number of minutes or a number of hours to complete and can consume resources (e.g., memory, processing capacity of one or more processors) of one or more servers during the time the raw data 104 is being processed. A processing time of a number of minutes or a number of hours can be unacceptable to users who desire to query the raw data 104 interactively. Therefore, querying the raw data 104 directly can be impractical for some users.

A pre-aggregation process 106 can be performed on the raw data 104, using, e.g., a pre-aggregation engine. The pre-aggregation process 106 can include obtaining subsets of the raw data 104, such as subsets relating to one or more data items of interest, using code of a query language. One or more aggregation operations can be performed on the subsets of data to produce pre-aggregated data. Aggregation operations can be performed using code of the query language. The pre-aggregated data can be produced, for example, by aggregating (e.g., summing) values associated with the subsets of data. For example, the pre-aggregated data can include valid clicks of an advertisement from a publisher of the advertisement over a period of time, such as one day. The valid clicks can be used, for example, to calculate daily revenue for each of multiple publishers.

As illustrated by storing indicators 108 and 110, the pre-aggregated data can be stored sequentially, at each time interval, e.g., in rows 112, 114, and so on, in one or more pre-aggregated data tables 116. The pre-aggregated data tables 116 can include other rows, such as a row 118, etc. The pre-aggregation process 106 can be performed, for example, in response to a user input from, e.g., a remote device. As another example, the pre-aggregation process 106 can be performed automatically, such as at particular time intervals. For example, the pre-aggregation process can be configured to run once per day or once per week.

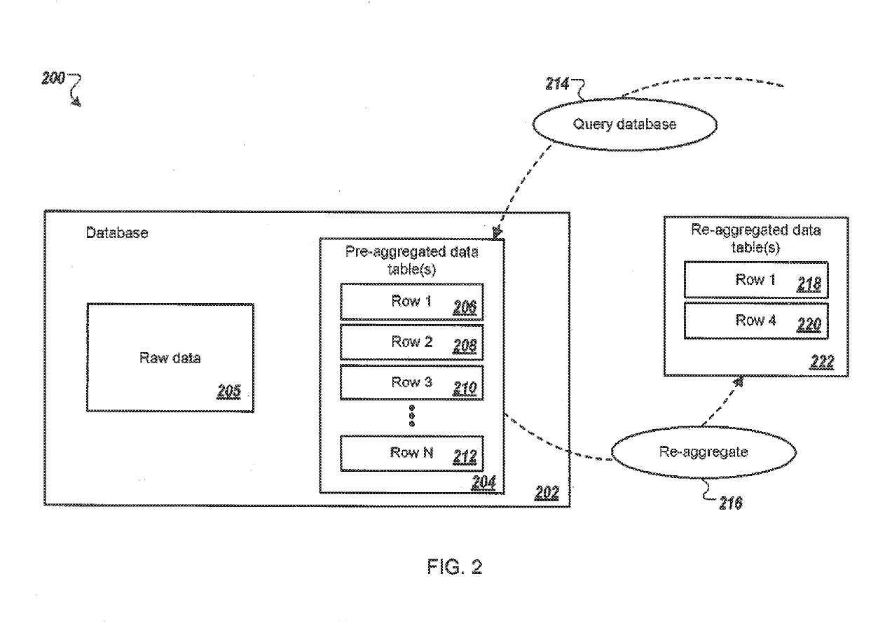

FIG. 2 is a block diagram showing how re-aggregation is performed. That database shown in FIG. 2 may include the same elements as that shown in FIG. 1, or those elements may be different. In this regard, FIG. 2 includes a database 202 that includes one or more pre-aggregated tables 204 and raw data 205. The raw data 205 can be, for example, the raw data 104 described above with respect to FIG. 1. The pre-aggregated tables 204 can be, for example, the pre-aggregated data tables 116 described above with reference to FIG. 1. The pre-aggregated tables 204 include rows 206, 208, 210, and 212.

A query 214 can be received, e.g., from a remote device operated by a user or operated without user interaction. The query 214 can be a query against the pre-aggregated data tables 204, instead of against the raw data 205. For example, if the pre-aggregated data tables 204 include daily revenue for each of multiple publishers, the query 214 can be a query to determine yearly revenue for one or more particular publishers.

In response to the query 214, at least some of the data in the pre-aggregated data tables 204 is obtained by a re-aggregation process 216 (performed, e.g., by a re-aggregation engine) using code written in the same query language used to produce the aggregated data tables 204 (e.g., code from the same query language used by the pre-aggregation process 106 described above with respect to FIG. 1). For example, if the query 214 is a query to determine yearly revenue for one or more particular publishers, the re-aggregation process 106 can obtain pre-aggregated data from one or more records from the pre-aggregated data tables 204 that are associated with the one or more particular publishers. The re-aggregation process 216 can perform one or more re-aggregation operations on the obtained data, using code from the query language, to produce re-aggregated data. The re-aggregation operations can include, for example, one or more of filtering, grouping, summing, or calculating derived expressions using pre-aggregated values included in the data obtained from the pre-aggregated data tables 204.

The re-aggregation engine can store the produced re-aggregated data. For example, the re-aggregation engine can store data in rows 218 and 220 of re-aggregated data tables 222. The re-aggregated data tables 222 can be included in a different database than the database 202 or can be included in the database 202. The re-aggregation engine can generate a report based on the produced re-aggregated data.

In general, queries ran against the pre-aggregated data tables 204 can be completed faster and can use fewer computing resources as compared to querying raw data (e.g., the raw data 104 described above with respect to FIG. 1). A developer using the system 200 can use the same query language for defining both the pre-aggregation and re-aggregation operations. Therefore, developer training costs for operating the system 200 can be reduced as compared to other environments that use one or more pre-aggregation languages that are different than a language used for re-aggregation.

Using the system 200, a developer can, while designing the query 214, first design, using the query language, a version of the query 214 that obtains data from the raw data 205 rather than the pre-aggregated data 204. The developer can test the version of the query 214 that obtains data from the raw data 205 to ensure that the query 214 is performing correctly. Once the developer confirms that the version of the query 214 that obtains data from the raw data 205 is performing correctly, the developer can alter the query 214, using the query language, to obtain data from the pre-aggregated data tables 204 rather than from the raw data 205. The version of the query 214 that obtains data from the pre-aggregated data tables 204 will generally run faster than the version of the query 214 that obtains data from the raw data 205.

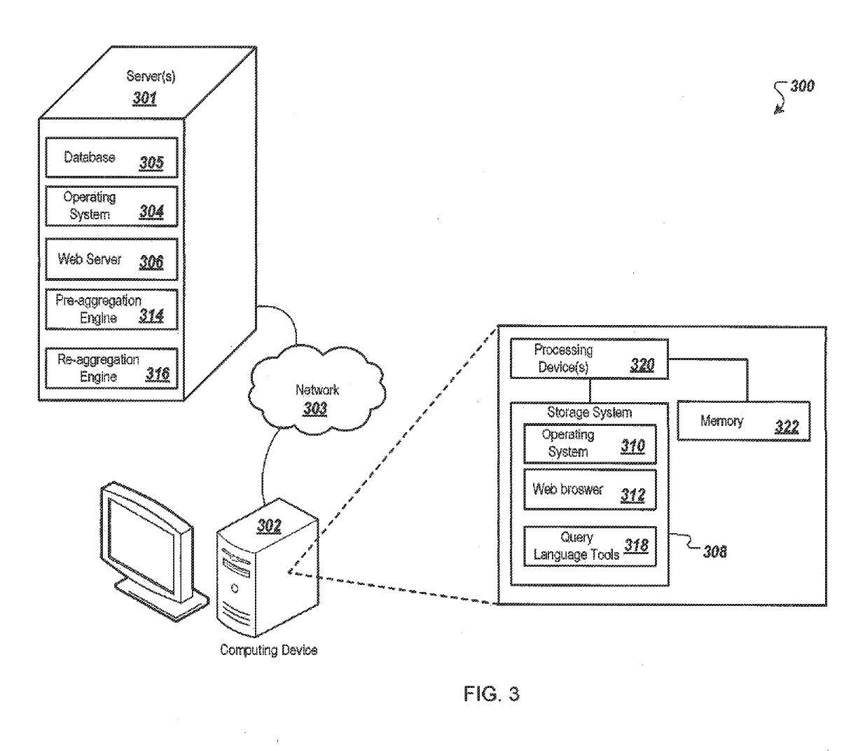

FIG. 3 is a block diagram of a system 300 on which the processes depicted conceptually in FIGS. 1 and 2 may be implemented. However, the processes of FIGS. 1 and 2 are not limited to use on a system having the architectural configuration of FIG. 3. Rather, the processes described herein can be implemented using any appropriate network, hardware, and software architectures. System 300 includes one or more servers 301 and one or more computing devices 302.

Server 301 and computing device 302 are connected via network 303. Network 303 represents a communications network that can allow the server 301 and the computing device 302 to communicate through a communication interface (not shown), which may include digital signal processing circuitry where necessary. Network 303 can include one or more networks available for use by computing device 302 for communication with server 301, such as a local area network, a wide area network, and/or the Internet.

The server 301 runs an operating system 304. The server 301 includes a database and a web server 306. The database 305 may be used, for example, to store raw data, such as log data, pre-aggregated data, and re-aggregated data. The database may also include a pre-aggregation engine 314 and a re-aggregation engine 316, which are executable by a processing device (not shown) associated with the database. Web server 306 may provide access to the database, the pre-aggregation engine, and or the re-aggregation engine.

The pre-aggregation engine 314 may be used for obtaining subsets of data from the database 305. The pre-aggregation engine 314 may perform pre-aggregation on the subsets of data to produce pre-aggregated data. The pre-aggregated data may be stored in the database 305. Pre-aggregation may be performed automatically (e.g., at time intervals) or pre-aggregation may be performed in response to a query or instruction from query language tools 318, which run on computing device 302, described below.

The re-aggregation engine 316 may be used for obtaining, in response to a query, e.g., from query language tools 318 on computing device 302, pre-aggregated data from the database 305. The re-aggregation engine 316 may perform one or more re-aggregations on the obtained pre-aggregated data to produce re-aggregated data. The re-aggregation engine 316 may generate a report using the re-aggregated data, for display in a web browser. Pre-aggregation engine 314 may be written in the same computing language as re-aggregation engine 316. Query language tools 318 may also be written in this same language.

The computing device 302 can be, for example, a desktop computer, a laptop computer, a handheld computer, a tablet computer, or a smartphone, to name a few examples. The computing device 302 may include a storage system 308 for storing an operating system 310, a web browser 312, and query language tools 318. The computing device 302 also includes one or more processing devices 320 (e.g., one or more microprocessors) and memory 322 (e.g., RAM), where the processing devices 320 can execute instructions stored in the memory 322. Computer programs, including the web browser 312, execute on top of the operating system 310. The web browser 312 may be used to access data or request resources from the web server 306, such as one or more user interfaces for designing and/or submitting queries.

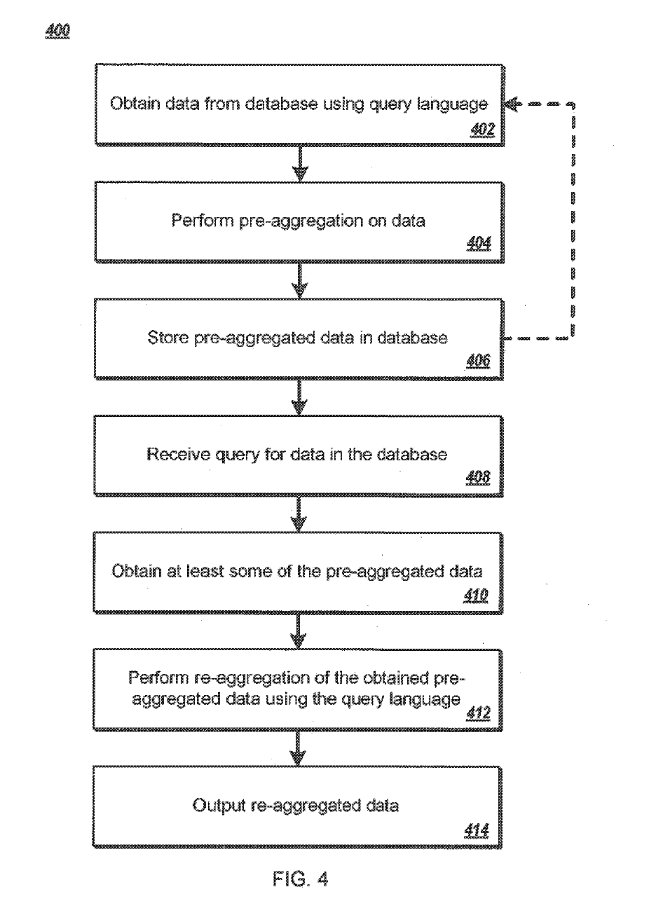

FIG. 4 is a flowchart showing a process 400 for performing pre-aggregation and re-aggregation using code written in the same query language. This code may implement the pre-aggregation engine and the re-aggregation engine described above to perform the pre-aggregation and re-aggregation operations of FIG. 4. According to process 400, a pre-aggregation engine obtains (402) subsets of data from a database using code of a query language. The engine can include, for example, one or more commands enabling multiple queries to the database. The engine can also perform multiple queries substantially concurrently.

The pre-aggregation engine performs (404) a pre-aggregation on the subsets of data to produce pre-aggregated data. Producing pre-aggregated data can include, for example, aggregating values associated with the subsets of data to produce pre-aggregated values. The pre-aggregated values can include, for example, sums or derived expressions generated via the performed pre-aggregation. If the subsets of data include, for example, click data for advertisements presented on publisher web pages, the pre-aggregated data can include, for example, valid clicks of an advertisement from a publisher of the advertisement over a period of time, such as a day.

The pre-aggregation engine stores (406) the pre-aggregated data in the database. For example, the pre-aggregated data can be stored as one or more tables in the database. In some implementations, the pre-aggregated data is stored in more than one database and/or in one or more files.

The pre-aggregation engine can perform the pre-aggregation in response to a user request to perform pre-aggregation. As another example, the pre-aggregation engine can perform the pre-aggregation automatically. For example, the pre-aggregation engine can be configured to perform the pre-aggregation at particular time intervals, such as to perform pre-aggregation on a periodic basis, such as daily. Therefore, multiple sets of pre-aggregated data can be produced and stored.

A re-aggregation engine receives (408) a query for data in the database. The query can be received, for example, from a user interface. In another example, the query can be received from a process executing on a remote device, such as computing device 302. In either case, the query can be made via query language tools 318.

The re-aggregation engine can obtain (410), in response to the query, at least some of the pre-aggregated data from the database. The re-aggregation engine can obtain the pre-aggregated data using code from the same query language used by the pre-aggregation engine. If the pre-aggregated data is stored in one more tables, the re-aggregation engine can obtain the pre-aggregated data from the one or more tables.

The re-aggregation engine performs (412) a re-aggregation on the pre-aggregated data to produce re-aggregated data. The re-aggregation engine can, for example, retrieve one or ra more pre-aggregated values and can filter, sum, group, derive one or more additional values, or perform other operations using the aggregated values. As an example, if the pre-aggregated data includes valid clicks of an advertisement from a publisher of the advertisement over a period of time (e.g., per day), the re-aggregated data can, for example, include valid clicks from a subset of the publishers over a same or different period of time. For example, if the pre-aggregated data includes valid click information on a per-day basis, the re-aggregated data can include valid click information on a per-month or per-year basis.

The re-aggregation engine outputs (414) re-aggregated data. For example, the re-aggregation engine can generate and output a report that uses or includes re-aggregated data. Generation of the report can be, for example, requested by or included as an instruction in the query. The re-aggregation engine can, over time, receive multiple queries, and can generate different re-aggregated data for each respective query, based on the same pre-aggregated data.

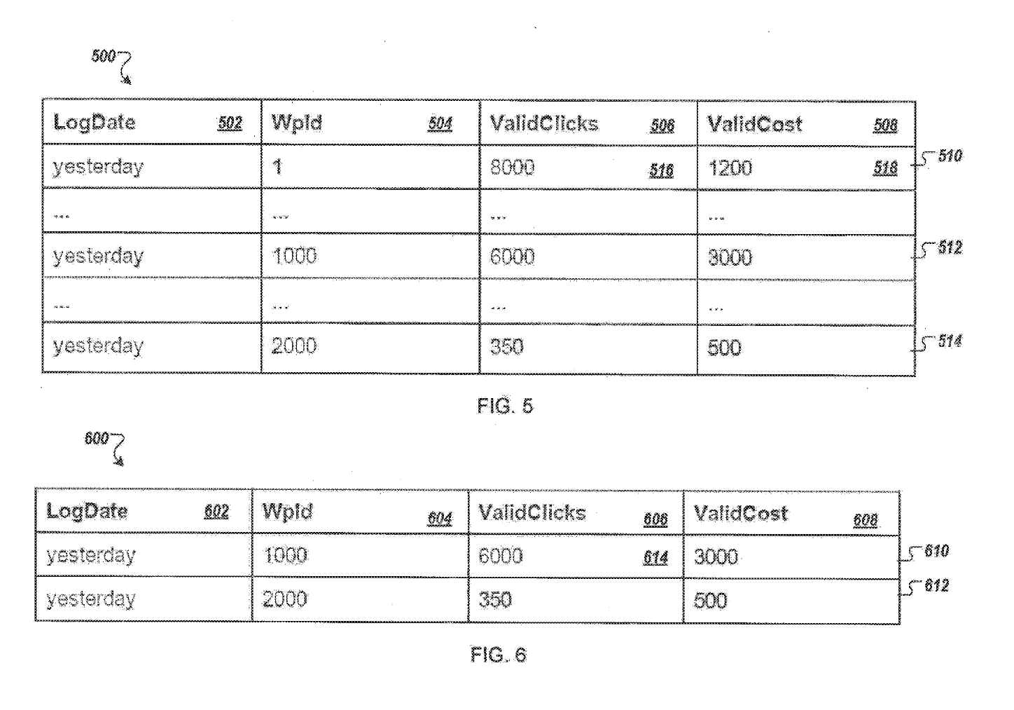

FIG. 5 is a diagram showing a table 500 of pre-aggregated data. The table 500 includes a log date column 502, a publisher identifier (Wpld) column 504, a valid clicks column a 506, and a valid cost column 508. The table 500 includes, among other rows, a row 510 associated with a publisher with identifier “1”, a row 512 associated with a publisher with identifier “1000”, and a row 514 associated with a publisher with identifier “2000”. In general, the table 500 can include a valid clicks amount and a valid cost amount for each publisher, for each of multiple days. The data in the table 500 can be produced, for example, using pre-aggregation query language code shown in lines three to eleven of Table 1.

TABLE 1

| # | Code |
|---|---|
| 1 | import click, cost, counts; |
| 2 | # The pre-aggregation step |
| 3 | view WpClicks(string log_date) = |
| 4 | select log_date as LogDate, |
| 5 | string(click.WpId) as WpId, |
| 6 | sum(counts.ValidClick) as ValidClicks, |
| 7 | sum(cost.ValidCost) as ValidCost, |
| 8 | from log_source(‘log_file_name’, log_date) |
| 9 | over impressions.clicks |
| 10 | where click.IsPaidClick |
| 11 | group by LogDate, WpId; |
| 12 | # The re-aggregation step |
| 13 | select LogDate, |
| 14 | WpId, |
| 15 | sum(ValidClicks) as ValidClicks, |
| 16 | sum(ValidCost) as ValidCost, |
| 17 | from WpClicks(‘yesterday’) |
| 18 | where WpId in (‘1000’, ‘2000’) |
| 19 | group by LogDate, WpId |
| 20 | order by LogDate, WpId; |

Line one of Table 1 specifies three libraries to import for use by other code shown in Table 1. Lines two and twelve of Table 1 are non-executable comments. The pre-aggregation query language code shown on lines three to eleven of Table 1 can be executed, for example, by the pre-aggregation engine. The pre-aggregation engine can, for example, execute the “WpClicks” pre-aggregation query periodically, such as daily.

Line three of Table 1 indicates that the “WpClick” pre-aggregation query accepts a log date parameter, which indicates a dale for which raw data (e.g., log data) is to be pre-aggregated. Line eight of Table 1 defines a source of raw data from which data is to be pre-aggregated. For example, a “log_source” data source is referenced, where a particular log file name, for log data matching the log date parameter, is indicated. The “log_source” data source can include, for example, a record for each click of each impression of an advertisement presented on a publisher web page for all advertisements managed by an advertisement management system. Lines nine and ten of Table 1 indicate a filter to be used when processing the log data. For example, log data associated with paid (e.g., revenue-producing) clicks on advertisement impressions can be processed.

Lines four to seven of Table 1 define the columns 502, 504, 506, and 508, respectively, included in the table 500. The columns 506 and 508 are each associated with a “sum” command (e.g., “sum(counts.ValidClick)”, “sum(cost.ValidClick)”, respectively). Each respective command sums log data in consideration of a grouping of log data by log date and publisher identifier, as indicated on line eleven of Table 1. For example, as indicated by a cell 516 included in the row 510, the total number of valid clicks for the publisher with identifier “1” for the date “yesterday” was determined by the execution of the “WpClicks” pre-aggregation query to be a value of “8000”. Similarly, as indicated by a cell 518 included in the row 510, the total cost for the publisher with identifier “1” (e.g., the cost to be paid to the publisher with identifier “1”) for the date “yesterday” was determined by the execution of the “WpClicks” pre-aggregation query to be a value of “1200”. The rows 512 and 514 include similar data for publishers with identifiers “1000” and “2000”, respectively.

FIG. 6 is a diagram showing a table 600 of re-aggregated data. The table 600 includes a log date column 602, a publisher identifier column 604, a valid clicks column 606, and a valid cost column 608. The table 600 includes a row 610 associated with a publisher with identifier “1000” and a row 612 associated with a publisher with identifier “2000”. The data in the table 600 can be produced, for example, by a re-aggregation engine executing re-aggregation query language code shown on lines thirteen to twenty of Table 1. The re-aggregation query language code shown on lines thirteen to twenty of Table 1 is written in the same query language as the previously described pre-aggregation query language code shown on lines three to eleven of Table 1.

The re-aggregation query language code on lines thirteen to twenty of Table 1 can be executed, for example, by the re-aggregation engine to query pre-aggregated data. The pre-aggregated data can be, for example, the data shown in the table 500 described above with respect to FIG. 5 and produced by the “WpClicks” pre-aggregation query defined on lines three to eleven of Table 1. The re-aggregation query language code on lines thirteen to twenty of Table 1 can be used to determine, from the pre-aggregated data, a total number of valid clicks and an associated cost of the valid clicks for two particular publishers (e.g., publishers with identifiers of “1000” and “2000”).

Lines thirteen to sixteen of Table 1 define the columns 602, 604, 606, and 608, respectively, of the table 600. The columns 606 and 608 are each associated with a “sum” command (e.g., “sum(ValidClicks)”, “sum(ValidCost)”, respectively). Each respective “sum” command sum pre-aggregated data in consideration of a grouping by log date and publisher identifier, as indicated by line nineteen of Table 1. For example, as indicated by a cell 614 included in the row 610, the total number of valid clicks for the publisher with identifier “1000” for the date “yesterday” is a value of “8000”.

The line seventeen of Table 1 indicates that the re-aggregation query code is to access a data source named as “WpClicks”. The data source “WpClicks” is defined, as described above, on lines three to eleven of Table 1, as a pre-aggregated data source. The line eighteen of Table 1 restricts re-aggregated data to include data associated with publishers having a publisher identifier of “1000” or “2000”.

As mentioned, the table 500 shown in FIG. 5 can include a valid clicks amount and a valid cost amount for fear each publisher, for each of multiple days. As an example, a re-aggregation query can be defined to determine a monthly revenue value for a particular publisher by querying a pre-aggregated data source such as the table 500. For example, a date range specifying a given month can be provided as a query parameter for querying a pre-aggregated data source. As another example, re-aggregation query code can include iteration code that iterates over all days of a given month and other code that sums revenue for individual days to determine a monthly revenue. In either example, querying the pre-aggregated data source can be performed much faster than querying a raw data source.

In general, re-aggregation code such as the re-aggregation query language code shown in Table 1 can be performed multiple times, such as on multiple days by the same user, or multiple times by different users. Each execution of the re-aggregation query language code can be executed against the same set of pre-aggregated data, such as if multiple executions of the re-aggregation query language code are performed on the same day, by the same or different users.

Some of the query language code used in Table 1 forms an abstraction layer which can enable seamless querying of different raw data sources and different pre-aggregated data sets. For example, as described, the re-aggregation query language code on lines thirteen to twenty references a “WpClicks” pre-aggregated data source. The “WpClicks” pre-aggregated data source can be redefined to be one of many possible types of pre-aggregated data and the re-aggregation query language statements can be executed unchanged and at run time can access different pre-aggregated data. As another example, the pre-aggregation query language code on lines three to eleven of Table 1 includes code referencing a “log_source” raw data source. One or more of multiple, available raw data sources can be substituted for the “log_source” raw data source, and the re-aggregation query language code can run unchanged.

In some implementations, some or all pre-aggregation query language code can be automatically generated and/or some or all query language code that does not reference pre-aggregated data structures can be automatically modified to query against pre-aggregated data. For example, an automation tool can examine a first set of query language code that does not reference any pre-aggregated data sources and can identify candidate expressions for pre-aggregation. The automation tool can automatically generate a second set of query language code which generates pre-aggregated data which can be used by the first set of query language code and can modify the first set of query language code to use the second set of query language code instead of a data source that is not pre-aggregated.

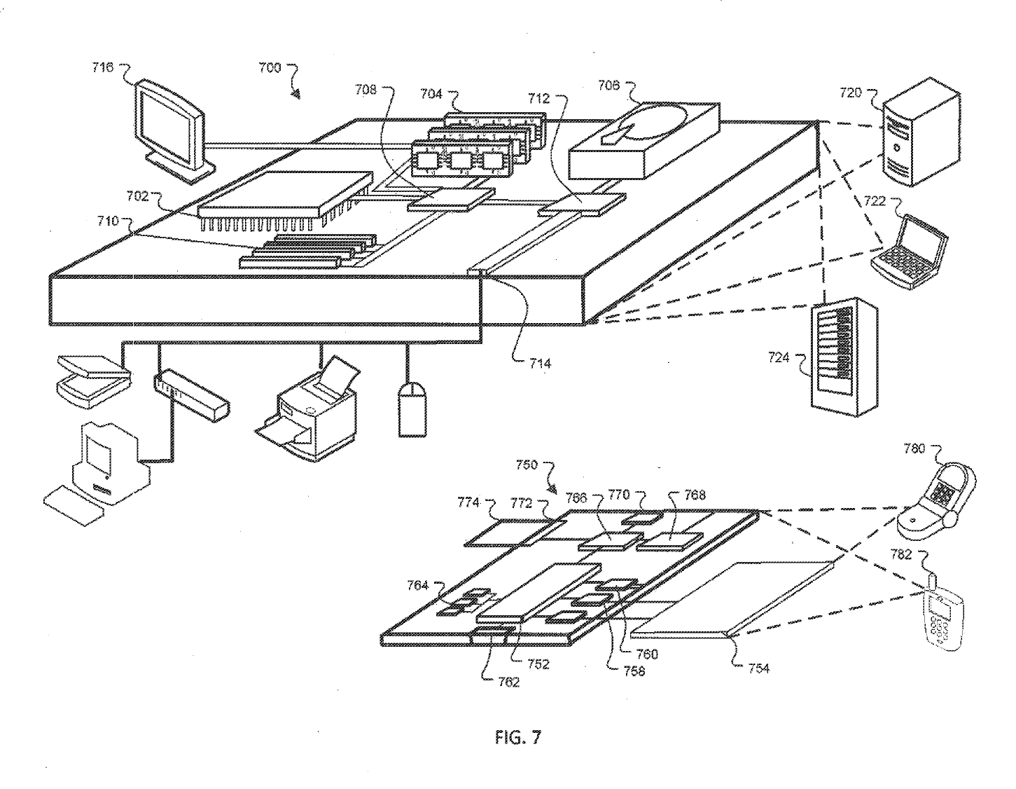

FIG. 7 shows an example of a generic computer device 700 and a generic mobile computer device 750, which may be used to implement the processes described herein. Computing device 700 is intended to represent various forms of digital computers, such as laptops, desktops, workstations, personal digital assistants, servers, blade serve mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various buses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar olid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable medium, such as the memory 704, the storage device 706, or memory on processor 702. Other examples of non-transitory machine-readable storage media include, but are not limited to, read-only memory, an optical disk drive, memory disk drive, random access memory, and the like.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and a display interface coupled to a display 754. The display 754 may be, for example, a TFT LCD (Thin-Film-Transistor Liquid Crystal Display) or an OGLED (Organic Light Emitting Diode) display, or other appropriate display technology. The display interface may comprise appropriate circuitry far driving the display 754 to present graphical and other information to a user. The control interface 758 may receive commands from a user and convert them submission to the processor 752. In addition, an external interface 762 may be provide in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier may be a computer- or machine-readable medium, such as the memory 764, expansion memory 774, and/or a memory on processor 752.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, Wi-Fi, or other such transceiver (not shown). In addition, GPS (Global Positioning System) receiver module 770 may provide additional navigation- and location-related wireless data to device 740, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g. visual feedback, auditory feedback, or tactile feedback); and input from the user can be received in any form, including acoustic, speech, or tactile input.

The systems and techniques described here can be implemented in, a computing system that include back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described, Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Elements of different implementations described herein may be combined to form other implementations not specifically set forth above. Elements may be left out of the processes, computer programs, Web pages, etc. described herein without adversely affecting their operation. Furthermore, various separate elements may be combined into one or more individual elements to perform the functions described herein.

Other implementations not specifically described herein are also within the scope of the following claims.

What is claimed is:

1. A method performed by one or more processing devices, comprising:
obtaining, at time intervals, subsets of data from a database using code of a query language;
performing a pre-aggregation on the subsets of data produce pre-aggregated data;
storing the pre-aggregated data in the database;
obtaining, in response to a query, at least some of the pre-aggregated data from the database, the at least some of the pre-aggregated data being obtained using code from the query language used to obtain the subsets of data; and
performing a re-aggregation on the pre-aggregated data to produce re-aggregated data.

2. The method of claim 1, further comprising generating a report using the re-aggregated data, the query requesting generation of the report.

3. The method of claim 1, wherein the pre-aggregation comprises aggregating values associated with the subsets of data to produce pre-aggregated values, the pre-aggregated values comprising sums generated via the pre-aggregation; and
wherein the re-aggregation comprises retrieving one or more pre-aggregated values.

4. The method of claim 1, wherein the query language comprises one or more commands enabling multiple queries to the database.

5. The method of claim 4, wherein the multiple queries are substantially concurrent.

6. The method of claim 1, wherein the pre-aggregated data comprises valid clicks of an advertisement from a publisher of the advertisement over a period of time; and
wherein the re-aggregated data comprises valid clicks from multiple publishers of the advertisement over a period of time.

7. The method of claim 1, wherein pre-aggregation is performed once, and the pre-aggregated data is used for multiple re-aggregations.

8. The method of claim 1, wherein pre-aggregation is stored automatically, and the time intervals are periodic.

9. The method of claim 1, wherein the pre-aggregated data is stored as one or more tables in the database, the at least some of the pre-aggregated data being obtained from the one or more tables.

10. One or more non-transitory machine-readable media storing instructions that are executable by one or more processing devices to perform operations comprising:
obtaining, at time intervals, subsets of data from a database using code of a query language;
performing a pre-aggregation on the subsets of data to produce pre-aggregated data;
storing the pre-aggregated data in the database;
obtaining, in response to a query, at least some of the pre-aggregated data from the database, the at least some of the pre-aggregated data being obtained using code from the query language used to obtain the subsets of data; and
performing a re-aggregation on the pre-aggregated data to produce re-aggregated data.

11. The one or more non-transitory machine-readable media of claim 10, wherein the operations comprise generating a report using the re-aggregated data, the query requesting generation of the report.

12. The one or more non-transitory machine-readable media of claim 10, wherein the pre-aggregation comprises aggregating values associated with the subsets of data to produce pre-aggregated values, the pre-aggregated values comprising sums generated via the pre-aggregation; and
wherein the re-aggregation comprises retrieving one or more pre-aggregated values.

13. The one or more non-transitory machine-readable media of claim 10, wherein the query language comprises one or more commands enabling multiple queries to the database.

14. The one or more non-transitory machine-readable media of claim 13, wherein the multiple queries are substantially concurrent.

15. The one or more non-transitory machine-readable media of claim 10, wherein the pre-aggregated data comprises valid clicks of an advertisement from a publisher of the advertisement over a period of time; and
wherein the re-aggregated data comprises valid clicks from multiple publishers of the advertisement over a period of time.

16. The one or more non-transitory machine-readable media of claim 10, wherein pre-aggregation is performed once, and the pre-aggregated data is used for multiple re-aggregations.

17. The one or more non-transitory machine-readable media of claim 10, wherein pre-aggregation is performed automatically, and the time intervals are periodic.

18. The one or more non-transitory machine-readable media of claim 10, wherein the pre-aggregated data is stored as one or more tables in the database, the at least some of the pre-aggregated data being obtained from the one or more tables.

19. A system comprising:
a pre-aggregation engine for obtaining, at time intervals, subsets of data from a database using code of a query language, for performing a pre-aggregation on the subsets of data to produce pre-aggregated data, and for storing the pre-aggregated data in the database; and
a re-aggregation engine for obtaining, in response to a query, at least some of the pre-aggregated data from the database, the at least some of the pre-aggregated data being obtained using code from the query language used to obtain the subsets of data, and for performing a re-aggregation on the pre-aggregated data to produce re-aggregated data.

20. A system comprising:
memory storing instructions that are executable; and
a processing device for executing the instructions to perform operations comprising:
obtaining, at time intervals, subsets of data from a database using code of a query language;
performing a pre-aggregation on the subsets of data to produce pre-aggregated data;
storing the pre-aggregated data in the database;
obtaining, in response to a query, at least some of the pre-aggregated data from the database, the at least some of the pre-aggregated data being obtained using code from the query language used to obtain the subsets of data; and
performing a re-aggregation on the pre-aggregated data to produce re-aggregated data.
